(19) United States
(12) Patent Application Publication
(10) Pub. No.: US 2016/0345026 A1
(43) Pub. Date: Nov. 24, 2016

(54) METHOD AND APPARATUS FOR ENCODING, DECODING A VIDEO SIGNAL USING AN ADAPTIVE PREDICTION FILTER

(71) Applicant: LG ELECTRONICS INC., Seoul (KR)

(72) Inventor: Onur G. GULERYUZ, San Francisco, CA (US)

(21) Appl. No.: 15/107,849

(22) PCT Filed: Jan. 2, 2015
(86) PCT No.: PCT/KR2015/000022

§ 371 Date: Jun. 23, 2016

Related U.S. Application Data
(60) Provisional application No. 61/922,859, filed on Jan. 1, 2014.

(51) Int. Cl. H04N 19/82; H04N 19/91; H04N 19/176; H04N 19/147; H04N 19/139; H04N 19/513; H04N 19/117

(52) U.S. Cl. CPC H04N 19/82; H04N 19/521; H04N 19/91; H04N 19/117; H04N 19/147; H04N 19/139; H04N 19/176

(57) ABSTRACT

Disclosed herein is a method of calculating a displacement vector of a target region; determining an anchor region by using the calculated displacement vector; predicting a target region by linearly filtering the anchor region using a designed filter; and generating a prediction error by using the predicted target region.

### TECHNICAL FIELD

The present invention relates to a method and apparatus for processing a video signal and, more particularly, to a technology for efficiently predicting a target region.

### BACKGROUND ART

Compression coding means a series of signal processing technologies for sending digitalized information through a communication line or storing digitalized information in a form suitable for a storage medium. Media, such as video, an image, and voice, may be the subject of compression coding. In particular, a technology for performing compression coding on video is called video compression.

The next-generation video content expects to feature high spatial resolution, a high frame rate, and high dimensionality of a video scene representation. The processing of such content would require a significant increase in memory storage, a memory access rate, and processing power.

Accordingly, it is desirable to design a coding tool which address these foreseen challenges and offer some solutions.

### DISCLOSURE

### Technical Problem

In an existing inter-prediction method, the target image is composed into fixed regions, such as rectangular regions, square regions, etc., and for each target region a displacement vector is calculated. The displacement vector identifies a corresponding region in the anchor image or the reference image. Such a displacement vector can be calculated by techniques well known in the art such as motion estimation/compensation techniques for video sequences.

Accordingly, it is necessary to provide a more efficient prediction method in the prediction process, and to design a prediction filter for enhancing the coding efficiency.

### Technical Solution

An embodiment of the present invention provides a method of enabling the design of a coding tool for high efficiency compression.

Furthermore, an embodiment of the present invention provides a more efficient prediction method in the prediction process.

Furthermore, an embodiment of the present invention provides how to design a prediction filter for enhancing the coding efficiency.

Furthermore, an embodiment of the present invention is to apply to a step that requires inter-picture relating filter in a process of encoding or decoding a video signal.

Furthermore, an embodiment of the present invention provides a method of better predicting the target region.

### Advantageous Effects

The present invention can enable the design of a coding tool for high efficiency compression. The compression tool having a higher coding gain can be designed by removing noise in predicting the target region.

Furthermore, the present invention can provide a more efficient prediction method by designing a prediction filter. And, the noise of target image can be reduced by utilizing the designed filter in motion compensated prediction of future frames, and thereby the coding efficiency can be enhanced.

### DESCRIPTION OF DRAWINGS

FIGS. 1 and 2 illustrate schematic block diagrams of an encoder and decoder which process a video signal in accordance with embodiments to which the present invention is applied.

FIG. 3 represents a drawing illustrating how to predict a target image based on an anchor image in accordance with an embodiment to which the present invention is applied.

FIGS. 4 and 5 illustrate schematic block diagrams of an encoder and decoder which process a video signal using the designed filters in accordance with embodiments to which the present invention is applied.

FIG. 6 is a flowchart illustrating a method of forming a prediction block based on a prediction filter in accordance with an embodiment to which the present invention is applied.

FIG. 7 is a diagram illustrating quad-tree partitions to which the prediction filter can be applied in accordance with an embodiment to which the present invention is applied.

FIG. 8 is a flowchart illustrating a method of obtaining optimal motion vector and modulation scalar in accordance with an embodiment to which the present invention is applied.

FIG. 9 is a flowchart illustrating a method of obtaining metric in accordance with an embodiment to which the present invention is applied.

FIG. 10 is a flowchart illustrating a method of encoding a video signal using the prediction filter in accordance with an embodiment to which the present invention is applied.

FIG. 11 is a flowchart illustrating a method of decoding a video signal using the prediction filter in accordance with an embodiment to which the present invention is applied.

### BEST MODE

In accordance with an aspect of the present invention, there is provided a method of encoding a video signal, comprising: calculating a displacement vector of a target region; determining an anchor region by using the calculated displacement vector; predicting a target region by linearly filtering the anchor region using a designed filter; and generating a prediction error by using the predicted target region.

The designed filter is determined based on a filter kernel component and modulation scalar component.

The modulation scalar component is determined to minimize a sum of a distortion component and a rate component.

The modulation scalar component for every inter-block is transmitted to a decoder.

The filter kernel component is optionally transmitted to a decoder.

When the anchor region is comprised of a plurality of sub-regions, the designed filter is generated for each of the sub-regions.

In accordance with another aspect of the present invention, there is provided a method of decoding a video signal, comprising: receiving the video signal including a filter parameter and a motion parameter, wherein the filter parameter includes a modulation scalar component; determining an anchor region based on the motion parameter; predicting a target region based on the anchor region and the modulation scalar component; and reconstructing the video signal by using the predicted target region.

The modulation scalar component has been determined to minimize a sum of a distortion component and a rate component.

The target region is predicted based on the modulation scalar component for every inter-block.

The target region is predicted based on the modulation scalar component and predetermined filter kernel component.

In accordance with another aspect of the present invention, there is provided an apparatus of encoding a video signal, comprising: a prediction unit configured to calculate a displacement vector of a target region, and determine an anchor region by using the calculated displacement vector; a prediction filtering unit configured to predict a target region by linearly filtering the anchor region using a designed filter, and generate a prediction error by using the predicted target region.

In accordance with another aspect of the present invention, there is provided an apparatus of decoding a video signal, comprising: an entropy decoding unit configured to receive the video signal including a filter parameter and a motion parameter, wherein the filter parameter includes a modulation scalar component; a prediction unit configured to determine an anchor region based on the motion parameter; a prediction filtering unit configured to predict a target region based on the anchor region and the modulation scalar component; and a reconstruction unit configured to reconstruct the video signal by using the predicted target region.

### Mode for Invention

Hereinafter, exemplary elements and operations in accordance with embodiments of the present invention are described with reference to the accompanying drawings. It is however to be noted that the elements and operations of the present invention described with reference to the drawings are provided as only embodiments and the technical spirit and kernel configuration and operation of the present invention are not limited thereto.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be construed as being based on only the name of a term used in a corresponding description of this specification and that the present invention should be construed by checking even the meaning of a corresponding term.

Furthermore, terms used in this specification are common terms selected to describe the invention, but may be replaced with other terms for more appropriate analysis if such terms having similar meanings are present. For example, a signal, data, a sample, a picture, a frame, and a block may be properly replaced and interpreted in each coding process.

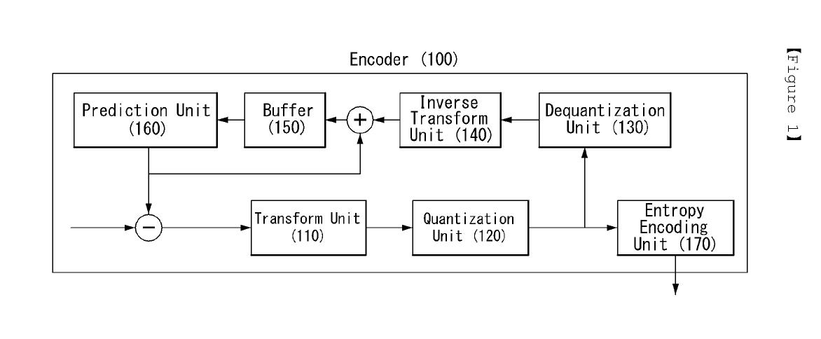

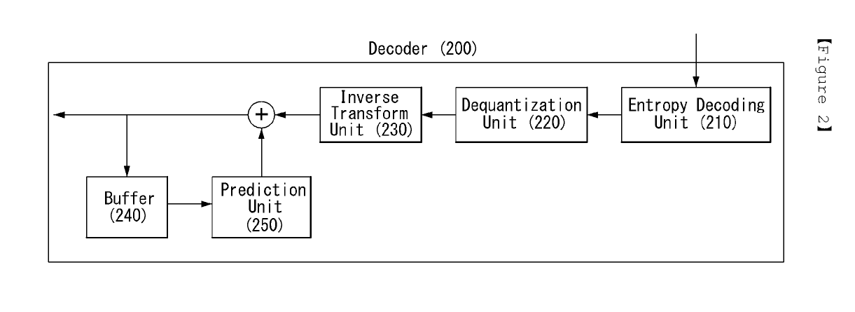

FIGS. 1 and 2 illustrate schematic block diagrams of an encoder and decoder which process a video signal in accordance with embodiments to which the present invention is applied.

The encoder 100 of FIG. 1 includes a transform unit 110, a quantization unit 120, a dequantization unit 130, an inverse transform unit 140, a buffer 150, a prediction unit 160, and an entropy encoding unit 170.

The encoder 100 receives a video signal and generates a prediction error by subtracting a predicted signal, output by the prediction unit 160, from the video signal.

The generated prediction error is transmitted to the transform unit 110. The transform unit 110 generates a transform coefficient by applying a transform scheme to the prediction error.

The quantization unit 120 quantizes the generated transform coefficient and sends the quantized coefficient to the entropy encoding unit 170.

The entropy encoding unit 170 performs entropy coding on the quantized signal and outputs an entropy-coded signal.

Meanwhile, the quantized signal output by the quantization unit 120 may be used to generate a prediction signal. For example, the dequantization unit 130 and the inverse transform unit 140 within the loop of the encoder 100 may perform dequantization and inverse transform on the quantized signal so that the quantized signal is reconstructed into a prediction error. A reconstructed signal may be generated by adding the reconstructed prediction error to a prediction signal output by the prediction unit 160.

The buffer 150 stores the reconstructed signal for the future reference of the prediction unit 160.

The prediction unit 160 generates a prediction signal using a previously reconstructed signal stored in the buffer 150. In this case, the present invention concerns efficient prediction of a region in a target image using a region in an anchor image. Efficiency can be in compression rate-distortion sense or in terms of related metrics such as mean-squared-error that quantify the distortion in the prediction error.

To better predict the target region, an embodiment of the present invention will explain how to design a prediction filter for enhancing the coding efficiency, and how to process a video signal based on the prediction filter.

The decoder 200 of FIG. 2 includes an entropy decoding unit 210, a dequantization unit 220, an inverse transform unit 230, a buffer 240, and a prediction unit 250.

The decoder 200 of FIG. 2 receives a signal output by the encoder 100 of FIG. 1.

The entropy decoding unit 210 performs entropy decoding on the received signal. The dequantization unit 220 obtains a transform coefficient from the entropy-decoded signal based on information about a quantization step size. The inverse transform unit 230 obtains a prediction error by performing inverse transform on the transform coefficient. A reconstructed signal is generated by adding the obtained prediction error to a prediction signal output by the prediction unit 250.

The buffer 240 stores the reconstructed signal for the future reference of the prediction unit 250.

The prediction unit 250 generates a prediction signal using a previously reconstructed signal stored in the buffer 240.

The prediction method to which the present invention is applied will be used in both the encoder 100 and the decoder 200.

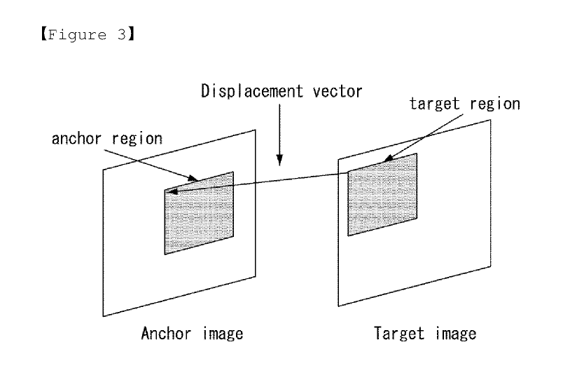

FIG. 3 represents a drawing illustrating how to predict a target image based on an anchor image in accordance with an embodiment to which the present invention is applied.

The target image can be composed into fixed regions, such as rectangular regions, square regions, etc., and for each target region a displacement vector can be calculated. The displacement vector identifies a corresponding region in the anchor image. Such a displacement vector can be calculated by techniques well known in the art such as motion estimation/compensation techniques for video sequences.

Concentrating on the target regions and matched anchor regions, the techniques of this invention can allow the matched anchor region to better predict the target region to facilitate applications like compression, denoising, spatio-temporal super-resolution, etc.

The anchor region x can be used to predict the target region y, via the following equation 1.

$$\hat{y} = {\sum }_{i = 1}^{F} {α}_{i} {f}_{i} * x \qquad [ Equation 1 ]$$

In equation 1, F is an integral constant (F-1,2,4,17,179, etc.), αᵢ denotes modulation scalars, fᵢ denotes two-dimensional filter kernels, and fᵢ*x denotes linear convolution of the filter kernel fᵢ with the anchor region.

It can be seen that the prediction ŷ of the target region y can be formed by linearly filtering the anchor region x using the equivalent filter f=Σᵢ₌₁^{F}αᵢfᵢ. The present invention provides a method of effectively designing such filters.

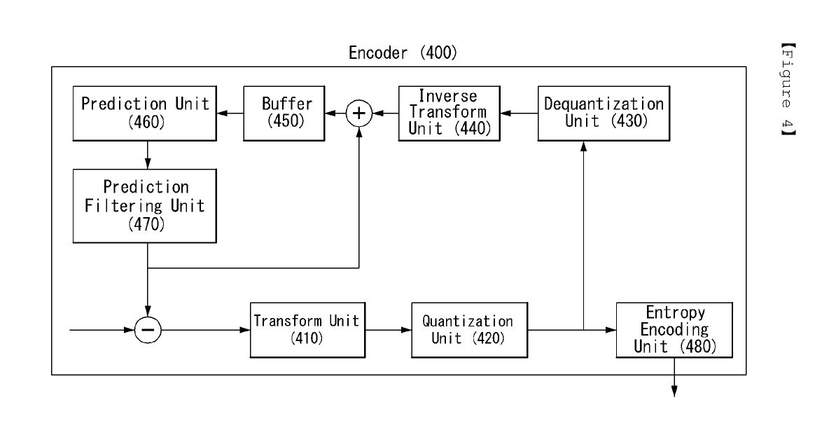

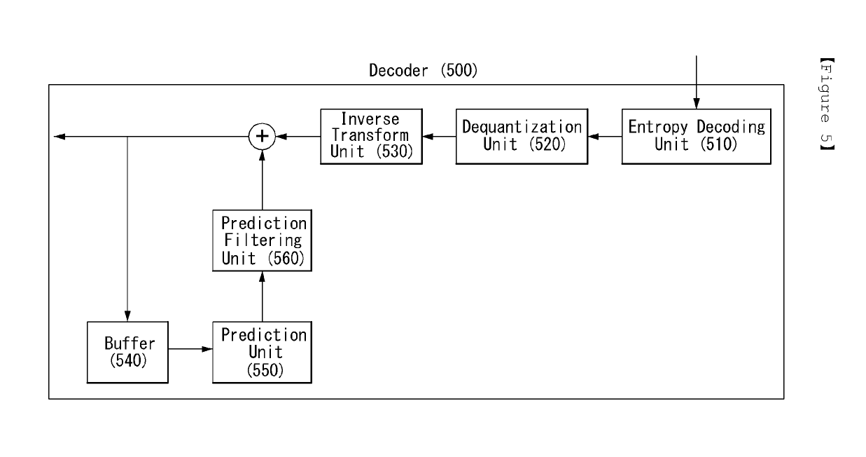

FIGS. 4 and 5 illustrate schematic block diagrams of an encoder and decoder which process a video signal using the designed filters in accordance with embodiments to which the present invention is applied.

The encoder 400 of FIG. 4 includes a transform unit 410, a quantization unit 420, a dequantization unit 430, an inverse transform unit 440, a buffer 450, a prediction unit 460, a prediction filtering unit 470 and an entropy encoding unit 480.

Comparing the encoder 400 with the encoder 100 of FIG. 1, the prediction filtering unit 470 is newly added to a block diagram of the encoder 100. Thus, the description of FIG. 1 can be similarly applied to FIG. 4, and the contents related to the prediction filtering unit 470 will be mainly explained hereinafter.

Furthermore, even though the prediction filtering unit 470 is placed as a separate functional unit after the prediction unit 460 in FIG. 4, this is an aspect of the present invention and the present invention are not limited thereto. For example, the function of the prediction filtering unit 470 can also be performed in the prediction unit 460.

The prediction unit 460 can perform a motion compensation using a displacement vector for a current block, and search a reference block, i.e. motion compensated block. In this case, the encoder 400 can transmit motion parameter to the decoder 500. The motion parameter represents information related to the motion compensation.

In an aspect of the present invention, the prediction filtering unit 470 can construct a prediction filter used for generating a prediction block.

And, the prediction filtering unit 470 can generate the prediction block using linear convolution of the prediction filter and a reference block. In this case, the reference block can represent a motion compensated block, as the anchor region.

In one embodiment, the prediction filter can be constructed by using filter kernels and modulation scalars. The encoder 400 and decoder 500 can share filter parameter, and the filter parameter represents parameter information related to the prediction filter. For example, the filter parameter can include at least one of filter kernel and modulation scalar.

In one embodiment, both the encoder 400 and decoder 500 can use filter kernels and modulation scalars for constructing the prediction filter. In this case, the modulation scalars can be computed for every inter-block, and the filter kernels can be kept the same for the entire video or changed/sent infrequently as explained in later embodiments.

In another embodiment, the encoder 400 can transmit at least one of the filter kernels and the modulation scalars to the decoder 500. For example, the filter kernels can be optionally transmitted to decoder.

Meanwhile, the decoder 500 of FIG. 5 includes an entropy decoding unit 510, a dequantization unit 520, an inverse transform unit 530, a buffer 540, a prediction unit 550 and a prediction filtering unit 560.

As described in FIG. 4, in an aspect of the present invention, the prediction filtering unit 560 can construct a prediction filter used for generating a prediction block.

And, the prediction filtering unit 560 can generate the prediction block using linear convolution of the prediction filter and a reference block.

In this case, at least one of the filter kernel and the modulation scalar can be transmitted from the encoder 400. For example, the modulation scalar can be transmitted for every inter-block from the encoder 400, and the filter kernels can be optionally transmitted from the encoder 400.

Comparing the decoder 500 with the decoder 200 of FIG. 2, the prediction filtering unit 560 is newly added to a block diagram of the decoder 200. Thus, the descriptions of FIGS. 1, 2 and 4 can be similarly applied to FIG. 5.

Furthermore, even though the prediction filtering unit 560 is placed as a separate functional unit after the prediction unit 550 in FIG. 5, this is an aspect of the present invention and the present invention are not limited thereto. For example, the function of the prediction filtering unit 560 can also be performed in the prediction unit 550.

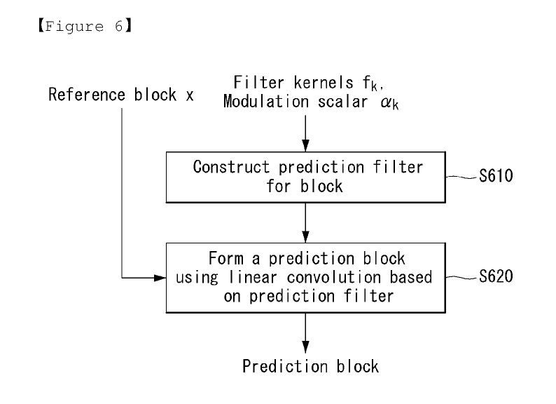

FIG. 6 is a flowchart illustrating a method of forming a prediction block based on a prediction filter in accordance with an embodiment to which the present invention is applied.

The encoder to which the present invention is applied can construct a prediction filter for a current block (S610), as the below equation 2. The prediction filter can be constructed by using filter paramters. For example, the filter paramters can include filter kernels fₖ and modulation scalars αᵢ (k=1, . . . , K).

$$g ( m , n ) = {\sum }_{k = 1}^{K} {f}_{k} ( m , n ) {α}_{i} \qquad [ Equation 2 ]$$

In this equation 2, m=1, T and n=1, . . . , T, and K is an integral constant, αᵢ denotes modulation scalars, fₖ denotes two-dimensional filter kernels, and each scalar is floating point number.

And then, the encoder can form a prediction block using linear convolution based on the prediction filter, as the below equation 3.

$$\hat{y} ( m , n ) = {\sum }_{p , q = 1}^{T} g ( p , q ) x ( m - p , n - q ) \qquad [ Equation 3 ]$$

In this equation 3, m=1, . . . , B and n=1, . . . , B, and g*x denotes linear convolution of the prediction filter with the anchor region. The anchor region can represent a reference block obtained after motion compensation.

The prediction ý of the target region y can be formed by linearly filtering the anchor region x using the prediction filter of equation 2.

Hereinafter, the present invention will provide various methods of effectively designing such filters.

In the process of video coding, designing general filters is difficult since such filters have many parameters, which must be learnt from limited data. Simple filters with reduced parameters are easier to learn but lead to unsatisfactory performance. Techniques that can specify effective filters with few parameters are hence highly desired.

In one embodiment, the filter kernels can be fixed and the modulation scalars can be computed to solve the constraint minimization as the following equation 4.

$${min}_{α} \{ {‖ y - {\sum }_{i = 1}^{F} {α}_{i} {f}_{i} * x ‖}_{q} + λ C ( {α}_{1} , {α}_{2} , … , {α}_{F} ) \} \qquad [ Equation 4 ]$$

In equation 4, α=[α₁ . . . α_{F}]^{T}, ∥.∥_{q} denotes the q-norm (for an n-vector e, ∥e∥_{q}=(Σⱼ₌₁ⁿ|eⱼ|^{q})^{1/q}, q=0,0.11,1,2,2.561, etc.), λ is a Lagrangian multiplier used to enforce the constraint C(α₁, α₂, . . . , α_{F})≦c₀, c₀ is a scalar, and C(α₁, α₂, . . . , α_{F}) is a constraint function.

In a compression setting C(α₁, α₂, . . . , α_{F}) can calculate the bits needed to communicate α so that the optimization finds the a that minimizes the q-norm of the prediction error subject to transmitting fewer than c₀ bits. C(α) can also be set as C(α)=∥α∥ₚ (p=0,0.11,1,2,2.561, etc).

The above minimization can solve the problem jointly in terms of α₁, α₂, . . . , α_{F}.

In one embodiment, the joint minimization can be simplified to scalar minimizations at some loss in accuracy by solving the following equation 5.

min_{α}_{ᵢ}{∥fᵢ*y−αᵢfᵢ*x∥_{q}+λᵢC(αᵢ)} for each αᵢ

The following equation 5 results in substantially easier solutions.

In one embodiment, the base filter kernels can be chosen to satisfy the following equation 6.

$${\sum }_{i = 1}^{F} {f}_{i} ( k , l ) = δ ( k , l ) \\ where \\ δ ( k , l ) = \{ \begin{matrix}1 , & k = l \\ 0 , & otherwise\end{matrix} . \qquad [ Equation 6 ]$$

In one embodiment, the base filter kernels can be defined as the following equation 7.

$${f}_{i} ( k , l ) = \frac{1}{2 π} {\int \int }_{( {ω}_{1} , {ω}_{2} ) ∈ {R}_{i}} {e}^{\sqrt{- 1} ( {ω}_{1} k + {ω}_{2} l )} d {ω}_{1} d {ω}_{2} \qquad [ Equation 7 ]$$

In equation 7, R=(−π, π]×(−π, π] determine the square two-dimensional interval of area π², and the measurable sets R₁, . . . , R_{F} denote a decomposition of R so that R=∪ᵢ₌₁^{F}Rᵢ and Rᵢ∩Rⱼ=Ø whenever i≠j . And, fᵢ is the inverse discrete-time

Fourier transform of the indicator function of Rᵢ.

Such filters may end up with non-compact support in spatial domain.

In another embodiment, compact support filters can be designed to approximate the non-compact support filters. For example, filters whose support can be restricted to a compact region Ω in spatial domain (e.g., Ω could be a rectangular region that limits the total number of taps of fᵢ to a prescribed number). Denoting the discrete-time Fourier transform of fᵢ with φᵢ,

$${χ}_{i} ( {ω}_{1} , {ω}_{2} ) = \{ \begin{matrix}1 , & ( {ω}_{1} , {ω}_{2} ) ∈ {R}_{i} \\ 0 , & otherwise\end{matrix}$$

can be the indicator function of Rᵢ. Given optimization weights βᵢ≧0, then the fᵢ can be chosen to minimize the following equation 8.

$$min {\sum }_{i = 1}^{F} [ {β}_{i} {{\int \int }_{- π}}^{π} {\vert {ϕ}_{i} ( {ω}_{1} , {ω}_{2} ) - {χ}_{i} ( {ω}_{1} , {ω}_{2} ) \vert}^{r} d {ω}_{1} d {ω}_{2} ] \qquad [ Equation 8 ]$$

In this case, Σᵢ₌₁^{F}fᵢ(k, l)=δ(k, l) and fᵢ(k, l)=0 if (k, l)∉Ω (r=0,0.11,1,2,2.561, etc.).

In another embodiment ψᵢ(ω₁, ω₂) are a given set of filters and the above minimization can be changed so that fᵢ approximate φᵢ, as the below equation 9.

$$min {\sum }_{i = 1}^{F} [ {β}_{i} {{\int \int }_{- π}}^{π} {\vert {ϕ}_{i} ( {ω}_{1} , {ω}_{2} ) - {ψ}_{i} ( {ω}_{1} , {ω}_{2} ) \vert}^{r} d {ω}_{1} d {ω}_{2} ] \\ where {\sum }_{i = 1}^{F} {f}_{i} ( k , l ) = δ ( k , l ) and \\ {f}_{i} ( k , l ) = 0 if ( k , l ) ∉ Ω . \qquad [ Equation 9 ]$$

In one embodiment, fᵢ can be designed with the aid of a training set. Given a target and anchor image pair concentrate on the convolution in the prediction formation, ŷ=Σᵢ₌₁^{F}αᵢfᵢ*x. Using the definition of convolution, equation 10 can be obtained.

$$\hat{y} ( m , n ) = {\sum }_{i = 1}^{F} {α}_{i} {\sum }_{( k , l ) ∈ Ω} {f}_{i} ( k , l ) x ( m - k , n - l ) \qquad [ Equation 10 ]$$

Lexicographically ordering the quantities into vectors, equation 11 can be obtained.

$$\hat{y} ( m , n ) = [ \begin{matrix} … & x ( m - k , n - l ) & …\end{matrix} ] [ \begin{matrix}⋮ & & ⋮ \\ {f}_{1} ( k , l ) & … & {f}_{F} ( k , l ) \\ ⋮ & & ⋮\end{matrix} ] [ \begin{matrix}{α}_{1} \\ ⋮ \\ {α}_{F}\end{matrix} ] \qquad [ Equation 11 ]$$

And, accommodating for all pixels (m,n) in the prediction, equation 12 can be obtained as follows.

$$\hat{y} = X [ \begin{matrix} & & \\ {f}_{1} & … & {f}_{F} \\ & & \end{matrix} ] [ \begin{matrix}{α}_{1} \\ ⋮ \\ {α}_{F}\end{matrix} ] = Xf α \qquad [ Equation 12 ]$$

Considering the lexicographically ordered target image, the optimal filters over the training set are obtained as the following equation 13.

min_{f}{min_{α}{∥y−Xfα∥_{q}+λC(α)}}

In another embodiment, the present invention can design filter kernels over training set as the below equation 14.

$${argmin}_{{f}_{1} , {f}_{2} , … , {f}_{K}} {\sum }_{s = 1}^{S} {min}_{α} {\sum }_{m , n = 1}^{B} [ {y}_{s} ( m , n ) - {{\sum }_{p , q = 1}^{T} ( {\sum }_{k = 1}^{K} {f}_{k} ( p , q ) {α}_{k} ) {x}_{s} ( m - p , n - q ) ]}^{2} \qquad [ Equation 14 ]$$

In this case, training pair of blocks can be defined with (y₁, x₁), (y₂, x₂), . . . , (yₛ, xₛ) (Sis a large integer, e.g., 100, 1000, 119191, etc).

And, the inner minimization

$${\sum }_{m , n = 1}^{B} {[ {y}_{s} ( m , n ) - {\sum }_{p , q = 1}^{T} ( {\sum }_{k = 1}^{K} {f}_{k} ( p , q ) {α}_{k} ) {x}_{s} ( m - p , n - q ) ]}^{2}$$

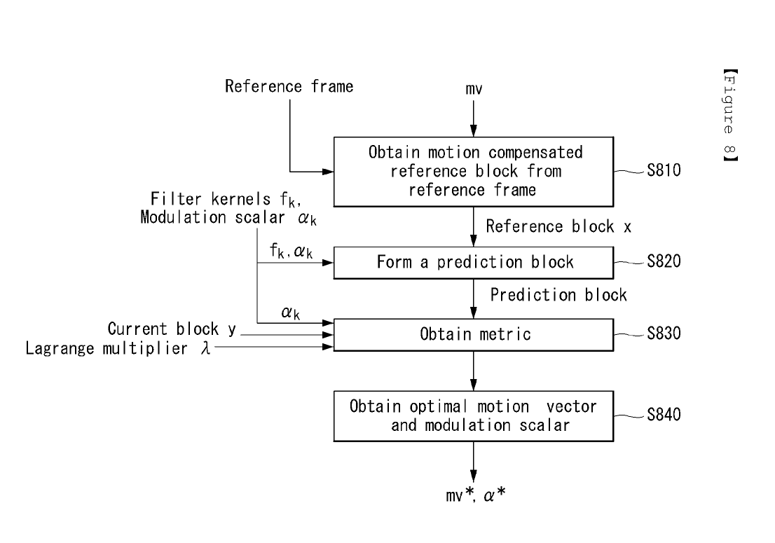

of equation 14 can be replaced with other embodiments of FIG. 8, e.g. equations 15 to 18.

In one embodiment, the encoder-decoder pair can perform the same optimization over previously transmitted frames (or parts of frames) of video sequences and utilize the resulting filters in motion compensated prediction of future frames (or parts of frames remaining for transmission).

In one embodiment, the quad-tree or other region decomposition optimization can be done jointly with the above optimization for f. In another embodiment motion compensation, optical flow, denoising, and other processing related optimizations can be done jointly with the above optimization for f.

In one embodiment, the interpolation filters used in motion compensation can be combined with the designed filters to lower the total filtering complexity.

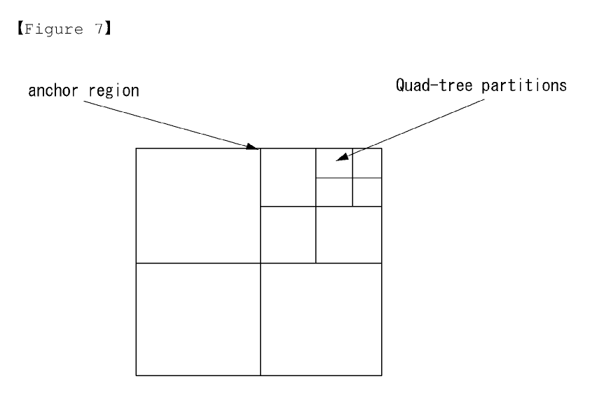

FIG. 7 is a diagram illustrating quad-tree partitions to which the prediction filter can be applied in accordance with an embodiment to which the present invention is applied.

Referring to the FIG. 7, in an aspect of the present invention, the anchor region can be further decomposed into sub-regions.

And, the prediction filters can be computed for each sub-region. This decomposition can be accomplished for example by using a quad-tree decomposition.

In a compression/communication setting, the present invention can design prediction filters allowing high performance prediction for each partition and signals the designed prediction filters to a decoder so that the same prediction can be accomplished at decoder.

Allowing for arbitrarily general filters, f, requires too many bits and as a result the encoder can only do coarse quad-tree partitioning (to limit the number of filters to transmit). This leads to a very limited adaptation to signal statistics. On the other hand designing very simple filters significantly restricts the filtering possibilities and results in ineffective prediction.

Accordingly, techniques that can specify effective prediction filters with few bits are highly desired, and the present invention will provide various techniques specifying effective prediction filters.

FIG. 8 is a flowchart illustrating a method of obtaining optimal motion vector and modulation scalar in accordance with an embodiment to which the present invention is applied.

In an aspect of the present invention, encoder can search for optimal motion vectors and modulation scalars, and the optimal motion vectors and modulation scalars can be transmitted to the decoder.

Firstly, the encoder can obtain motion compensated reference block from a reference frame(S810). In this case, the motion compensated reference block can be obtained by using a motion vector.

The encoder can form a prediction block based on the motion compensated reference block and filter parameters, the filter parameters including filter kernels and modulation scalars (S820). In this case, the modulation scalars can be computed for every inter-block, and the filter kernels can be kept the same for the entire video or changed/sent infrequently as explained in later embodiments. Furthermore, the various embodiments described in FIG. 6 can be applied to FIG. 8.

Hereinafter, the present invention provides various embodiments which calculate the modulation scalars.

In an aspect of the present invention, the modulation scalars can be searched in modulation scalar search range.

In another embodiment, the modulation scalars can be computed as the following equation 15.

$${argmin}_{α} {\sum }_{m , n = 1}^{B} [ y ( m , n ) - {{\sum }_{p , q = 1}^{T} ( {\sum }_{k = 1}^{K} {f}_{k} ( p , q ) {α}_{k} ) x ( m - p , n - q ) ]}^{2} \qquad [ Equation 15 ]$$

The modulation scalars according to equation 15 can be transformed and quantized to modulation scalar search range.

And, optimization of equation 15 can be done jointly with other optimization.

In another embodiment, the modulation scalars can be computed as the following equation 16.

$${argmin}_{{α}_{k}} {\sum }_{m , n = 1}^{B} [ {\sum }_{p , q = 1}^{T} {f}_{k} ( p , q ) y ( m - p , n - q ) - {{α}_{k} {f}_{k} ( p , q ) x ( m - p , n - q ) ]}^{2} \qquad [ Equation 16 ]$$

The modulation scalars according to equation 16 can be transformed and quantized. And, optimization of equation 16 can be done independently of other optimization and be repeated for each k.

In another embodiment, the modulation scalars can be computed as the following equation 17.

$${argmin }_{α} \{ {\sum }_{m , n = 1}^{B} [ y ( m , n ) - {{\sum }_{p , q = 1}^{T} ( {\sum }_{k = 1}^{K} {f}_{k} ( p , q ) {α}_{k} ) x ( m - p , n - q ) ]}^{2} + λ rate\_estimate ( α ) \} \qquad [ Equation 17 ]$$

The modulation scalars according to equation 17 can be quantized. And, equation 17 can be done with independent optimization rather than joint optimization.

In another embodiment, the modulation scalars can be computed as the following equation 16.

$${argmin }_{α} \{ {\sum }_{m , n = 1}^{B} [ y ( m , n ) - {{\sum }_{p , q = 1}^{T} ( {\sum }_{k = 1}^{K} {f}_{k} ( p , q ) {α}_{k} ) x ( m - p , n - q ) ]}^{2} - λ {log}_{2} ( probability ( α ) ) \} \qquad [ Equation 18 ]$$

The modulation scalars according to equation 18 can be quantized. And, equation 18 can be done with independent optimization rather than joint optimization.

And, the encoder can obtain metric based on the formed prediction block, the modulation scalars and lagrange multiplier (S830). For example, the metric can include optimization function (or value) comprised of rate component and distortion component.

And then, the encoder can obtain optimal motion vectors and modulation scalars based on the obtained metric (S840). For example, if the obtained metric is smaller than minimum metric or previously obtained metric, the minimum metric can be set to obtained metric. Thereby, the optimal motion vectors and the optimal modulation scalars can be determined and be transmitted to the decoder.

Otherwise, the above-mentioned processes can be repeated until the optimal motion vectors and the optimal modulation scalars can be obtained.

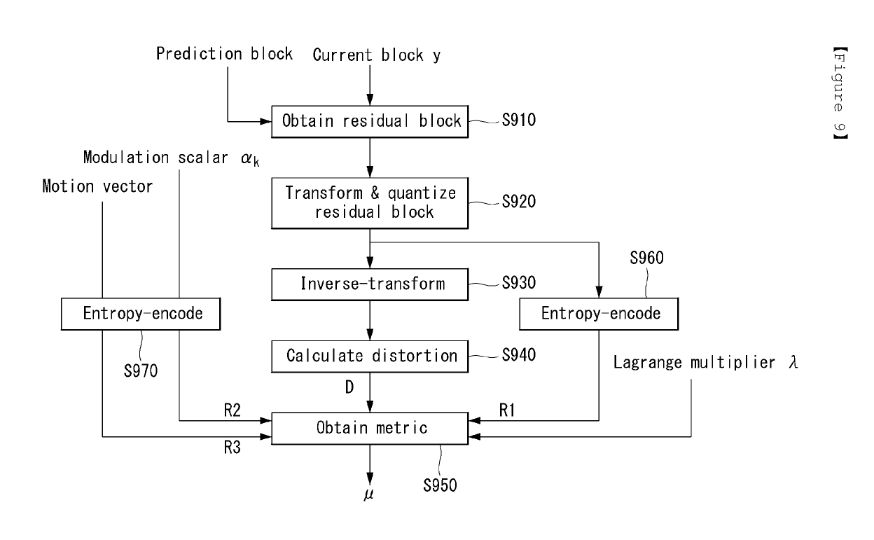

FIG. 9 is a flowchart illustrating a method of obtaining metric in accordance with an embodiment to which the present invention is applied.

In an aspect of the present invention, encoder can obtain metric search for optimal motion vectors and modulation scalars, and the optimal motion vectors and modulation scalars can be transmitted to the decoder.

Firstly, the encoder can obtain a residual block based on a current block and a prediction block (S910) In this case, the prediction block can be a block which has been predicted based on previously obtained metric.

The encoder can transform and quantize the residual block (S920). The quantized residual block can be entropy-encoded (S960), and the entropy-encoded residual block (R1) can be used to obtain metric.

Furthermore, the modulation scalars can be entropy-encoded (S970), and the entropy-encoded modulation scalars (R2) can be used to obtain metric.

In another embodiment, the modulation scalars can be calculated according to the below equation 19 and be used to obtain metric.

$$R 2 = C {\sum }_{k = 1}^{K} {α}^{q} \qquad [ Equation 19 ]$$

In equation 19, C is floating point normalizing constant, and q=0, 0.11, 0.2, 1, 1.2, 2, 5, 100.21, . . . .

In another embodiment, the encoder estimate probability distribution for the modulation scalars, as the below equation 20.

R2=−log₂(probability(α))

Similarly, the motion vector can also be entropy-encoded (S970), and the entropy-encoded motion vector (R3) can be used to obtain metric.

Meanwhile, the quantized residual block can be dequantized and inverse-transformed (S930).

And, the inverse-transformed residual block can be used to calculate distortion. In this case, the encoder can calculate distortion as the below equation 21.

$$D = {‖ \hat{r} ‖}_{2}^{2} = {\sum }_{m , n = 1}^{B} {( \hat{r} ( m , n ) )}^{2} \qquad [ Equation 21 ]$$

In equation 21, \hat{r} is the inverse-transformed residual block, and D represents distortion.

Thus, the encoder can obtain metric as the below equation 22.

μ=D+λ(R1+R2+R3)

In equation 22, D represents distortion component and (R1+R2+R3) represents rate component.

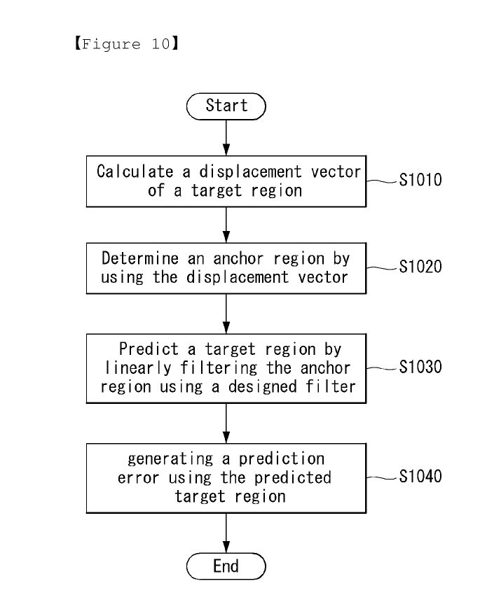

FIG. 10 is a flowchart illustrating a method of encoding a video signal using the prediction filter in accordance with an embodiment to which the present invention is applied.

The present invention provides a method of encoding a video signal using the prediction filter.

The encoder can calculate a displacement vector of a target region (S1010). In this case, the target region represents a region to be encoded within a current frame.

The encoder can determine an anchor region by using the displacement vector (S1020). In this case, the anchor region represents a region to be referred within a reference frame.

And, the encoder can predict the target region by linearly filtering the anchor image region using a designed filter (S1030). In this case, the prediction filter can be constructed by using filter parameters, and the filter parameter represents parameter information related to the prediction filter. For example, the filter parameter can include at least one of filter kernel and modulation scalar. Furthermore, the modulation scalars can be computed for every inter-block, and the filter kernels can be kept the same for the entire video or changed/sent infrequently. And, the filter kernels can be optionally transmitted to decoder.

And then, the encoder can generate a prediction error using the predicted target region (S1040).

In one embodiment, the designed filter can be determined based on a filter kernel component and modulation scalar component.

In one embodiment, the modulation scalar component can be determined to minimize a sum of a distortion component and a rate component

In one embodiment, when the anchor region is comprised of a plurality of sub-regions, the designed filter can be generated for each of the sub-regions.

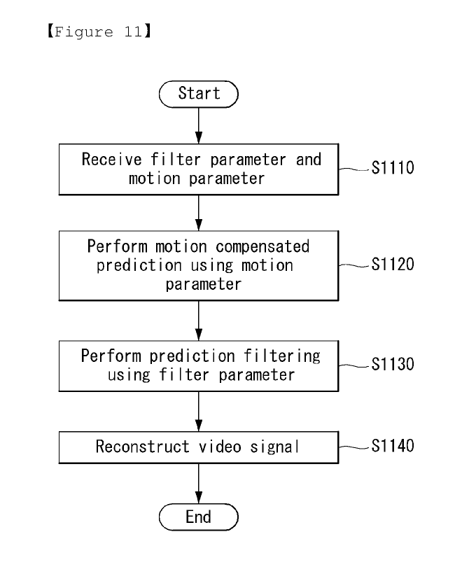

FIG. 11 is a flowchart illustrating a method of decoding a video signal using the prediction filter in accordance with an embodiment to which the present invention is applied.

The present invention provides a method of decoding a video signal using the prediction filter.

The decoder can receive a video signal including filter parameter and motion parameter (S1110).

The decoder can perform motion compensated prediction using motion parameter (S1120).

And, the decoder can perform prediction filtering using filter parameter (S1130).

And then, the decoder can reconstruct the video signal using a prediction filtered signal (S1140).

In one embodiment, modulation scalars for every inter-block within each frame can be transmitted to the decoder.

In one embodiment, filter kernels can be transmitted to the decoder once and used universally to code video, since filter kernels are sent infrequently and they can be finely quantized and sent using conventional techniques.

In one embodiment, targeting non-real time video compression, filter kernels can be computed and transmitted for the next M frames(e.g., M=30, 100, 2017, . . . ) to be coded. It can be performed by feeding frames to the training set generator and using the resulting pairs to design the kernels. And, it can be performed by sending the resulting filter kernels to the decoder. And then, the M frames can benefit from compression using the just sent kernels.

In one embodiment, the encoder and decoder can do the same calculations for computing filter kernels by using the M previously encoded frames to generate training pairs.

In one embodiment, filter kernels can be coded differentially with respect to previously sent filter kernels while sending to the decoder.

In one embodiment, the search range and discretization for modulation scalars is adjusted based on the size of the block to be filtered. In another embodiment, finer discretization of the search range can be allowed for larger blocks.

In one embodiment a similarity score between two pictures is computed as the distortion between them after motion-compensated advanced prediction filtering is performed.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional (3D) video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves (e.g., transmission through the Internet). Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of encoding a video signal, comprising:
calculating a displacement vector of a target region;
determining an anchor region by using the calculated displacement vector;
predicting a target region by linearly filtering the anchor region using a designed filter; and
generating a prediction error by using the predicted target region.

2. The method of claim 1,
wherein the designed filter is determined based on a filter kernel component and modulation scalar component.

3. The method of claim 2,
wherein the modulation scalar component is determined to minimize a sum of a distortion component and a rate component.

4. The method of claim 2,
wherein the modulation scalar component for every interblock is transmitted to a decoder.

5. The method of claim 2,
wherein the filter kernel component is optionally transmitted to a decoder.

6. The method of claim 1,
wherein when the anchor region is comprised of a plurality of sub-regions, the designed filter is generated for each of the sub-regions.

7. A method of decoding a video signal, comprising:
receiving the video signal including a filter parameter and a motion parameter, wherein the filter parameter includes a modulation scalar component;
determining an anchor region based on the motion parameter;
predicting a target region based on the anchor region and the modulation scalar component; and
reconstructing the video signal by using the predicted target region.

8. The method of claim 7,
wherein the modulation scalar component has been determined to minimize a sum of a distortion component and a rate component.

9. The method of claim 7,
wherein the target region is predicted based on the modulation scalar component for every inter-block.

10. The method of claim 7,
wherein the target region is predicted based on the modulation scalar component and predetermined filter kernel component.

11. An apparatus of encoding a video signal, comprising:
a prediction unit configured to calculate a displacement vector of a target region, and determine an anchor region by using the calculated displacement vector;
a prediction filtering unit configured to predict a target region by linearly filtering the anchor region using a designed filter, and generate a prediction error by using the predicted target region.

12. The apparatus of claim 11,
wherein the designed filter is determined based on a filter kernel component and modulation scalar component.

13. The apparatus of claim 12,
wherein the modulation scalar component is determined to minimize a sum of a distortion component and a rate component.

14. The apparatus of claim 12,
wherein the modulation scalar component for every inter-block is transmitted to a decoder.

15. The apparatus of claim 12,
wherein the filter kernel component is optionally transmitted to a decoder.

16. The apparatus of claim 11,
wherein when the anchor region is comprised of a plurality of sub-regions, the designed filter is generated for each of the sub-regions.

17. An apparatus of decoding a video signal, comprising:
an entropy decoding unit configured to receive the video signal including a filter parameter and a motion parameter, wherein the filter parameter includes a modulation scalar component;
a prediction unit configured to determine an anchor region based on the motion parameter;
a prediction filtering unit configured to predict a target region based on the anchor region and the modulation scalar component; and
a reconstruction unit configured to reconstruct the video signal by using the predicted target region.

18. The apparatus of claim 17,
wherein the modulation scalar component has been determined to minimize a sum of a distortion component and a rate component.

19. The apparatus of claim 17,
wherein the target region is predicted based on the modulation scalar component for every inter-block.

20. The apparatus of claim 17,
wherein the target region is predicted based on the modulation scalar component and predetermined filter kernel component.
